(19) United States
(12) Patent Application Publication
(10) Pub. No.: US 2007/0247717 A1
(43) Pub. Date: Oct. 25, 2007

(54) DISPLAY APPARATUS

(75) Inventors: Shunsuke KONNO, Kanagawa (JP); Takashi KUWABARA, Kanagawa (JP); Hisaya FUKUDA, Kanagawa (JP); Toshitomo UMEI, Kanagawa (JP); Noboru KATTA, Kanagawa (JP); Seiichi NAKAGAWA, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/737,463

(22) Filed: Apr. 19, 2007

Related U.S. Application Data
(60) Provisional application No. 60/876,979, filed on Dec. 26, 2006.

(30) Foreign Application Priority Data
Apr. 20, 2006 (JP) 2006-117273

(51) Int. Cl. G02B 27/00

(52) U.S. Cl. 359/613

(57) ABSTRACT

A display apparatus (100) comprise a display section (110) that displays image on a display screen; a viewer position reading section (520) that reads a relative position of at least one viewer with respect to the display screen; a glare detection section (111 to 114) that detects light reflected from external light toward the viewer to output the detected result as glare information; and an image quality correction section (500) that corrects image quality of the display section based on the glare information outputted by the glare detection section.

### CROSS REFERENCE TO RELATED APPLICATIONS

The disclosure of Japanese Patent Application No. 2006-117273, filed on Apr. 20, 2006, and provisional U.S. patent application No. 60/876979, filed on Dec. 26, 2006, including the specification, drawings and abstract, is incorporated herein by reference in its entirety.

### BACKGROUND OF THE INVENTION

1. Field of the Invention

The present invention relates to a display apparatus capable of displaying a plurality of images (including video), and, more particularly, to a display apparatus that displays a plurality of images in the interior of a vehicle.

2. Description of the Related Art

In recent years, with the progress of digital technologies and communication technologies, a wide variety of vehicle-mounted electronic devices have been made. In particular, display apparatuses, such as navigation systems, digital versatile disc (DVD) players, and television receivers that utilize a display, such as an LCD, to display images recorded on a recording medium such as a CD-ROM or DVD or the images of television broadcasting have become widely popular.

Further, with the development of luxury and large-sized vehicles in recent years, there is even a vehicle-mounted apparatus that has two display apparatuses. With such an apparatus, for example, by providing one display apparatus between the driver's seat and the front passenger's seat and providing the other display apparatus in front of the backseats, not only the driver and the passenger in the front passenger seat, but also the passengers in the backseats are able to view various information displayed on a display apparatus. If sunlight shines on such a display apparatus, the visibility severely deteriorates due to reflected light.

For example, Japanese Patent Application Laid-Open No. 2001-522058 discloses a display apparatus that automatically controls the brightness of the display. The display apparatus disclosed in Japanese Patent Application Laid-Open No. 2001-522058 provides a light sensor that detects the luminance of ambient light near the display and changes the brightness of the display based on the luminance detected by the light sensor. Thus, the brightness of the display is increased under the bright sunlight during the day and decreased at nighttime.

With this type of conventional vehicle-mounted display apparatus, however, the problem arises that visibility is still poor with respect to the reflected light from beams of sunlight, etc, for the reason described below.

FIG. 16 is a drawing explaining a display example of a display apparatus capable of displaying a plurality of images in the interior of a vehicle.

In FIG. 16A, 10 designates a display apparatus installed in the interior of a vehicle for the backseats, and 20 designates the backseats where viewers A and B to view the display screen of the display apparatus 10 are seated. The viewer seated in the left seat is “viewer A” and the viewer seated in the right seat is “viewer B.” The display apparatus 10 is capable of displaying two screens, a displaying screen 1 on the monitor screen directly in front of the viewer A of the left seat, and a screen 2 on the monitor screen directly in front of the viewer B of the right seat.

As shown in FIG. 16B, when sunlight shines directly on the display apparatus 10, direct light reflects on the monitor screen and enters the fields of vision of viewers A and B, making it difficult for viewers A and B to view the screens. The light reflected from the monitor screen has varying influences depending on the sun, the monitor screen, and the position of the viewer. In the case of FIG. 16B, viewer A is influenced little by reflected light and thus can view the screen 1 and the screen 2 of the monitor screen well. Viewer B, however, is influenced by reflected light and, since direct sunlight reflects on the screen 1 of the monitor screen in particular, has extreme difficulty viewing the screen 1. In this manner, depending on the position of the viewer, a screen becomes difficult to see due to the light reflected from the monitor screen.

Here, similar to the above-mentioned apparatus described in Japanese Patent Application Laid-Open No. 2001-522058, there are apparatuses that provide an external light sensor that detects the luminance of peripheral light near the display and change the brightness of the display based on the luminance detected by the external light sensor.

FIG. 17 is a drawing explaining a display example of a display apparatus that changes the luminance by an external light sensor. Components that are identical to those of FIG. 16 are assigned the same reference numerals. In FIG. 17, an external light sensor 30 is installed directly in front of the monitor screen of the display apparatus 10. The external light sensor 30 is comprised of components such as a light receiving element that detects the intensity of external light such as sunlight irradiated from an external source. The display apparatus 10 changes the luminance of the overall display in accordance with the surrounding brightness detected by the external light sensor 30 to reduce the influence of external light. If the display apparatus 10 has an LCD display, the change in luminance is adjusted by the brightness of the backlight arranged on the back of the LCD panel.

However, with a configuration that adjusts the luminance of the overall display according to the surrounding brightness detected by a single external light sensor, if viewers A and B seated side by side view a horizontally wide display apparatus, correction of the overall display by the single external light sensor arranged at the bottom center of the screen does not provide optimum luminance for either viewer A or B viewing the monitor screen. For example, when viewer B of the right seat is not in the vehicle and viewer A of the left seat alone views the monitor screen, viewer A is not influenced by the light reflected from the monitor screen, as shown in FIG. 17. In this case, even if viewer A prefers to view the monitor screen at the brightness level as is, the brightness is excessively adjusted to an excessively bright level by the change in the luminance of the overall display by the external light sensor. On the other hand, when viewer A of the left seat is not in the vehicle and viewer B of the right seat alone views the monitor screen, viewer B is severely influenced by the reflected light. In this case, even if viewer B wants the brightness to be adjusted to a brighter level, the brightness adjustment by the change in the luminance of the overall display is insufficient.

In this manner, with a conventional vehicle-mounted display apparatus, the brightness of the overall display is uniformly adjusted by an external light sensor without taking in to consideration particular conditions such as the capability of dual-screen display, a plurality of viewers seated side by side, or viewers viewing the screen from an extremely close position, thereby resulting in failure to achieve a visibility improvement effect with respect to light reflected from the monitor screen such as sunlight.

### SUMMARY OF THE INVENTION

It is therefore an object of the present invention to provide a display apparatus capable of improving visibility with respect to light reflected from the screen onto one or a plurality of viewers seated in the backseats of a vehicle.

A display apparatus according to an aspect of the present invention, employs a configuration having; a display section that displays image on a display screen; a viewer position reading section that reads a relative position of at least one viewer with respect to the display screen; a glare detection section that detects light reflected from external light toward the viewer to output the detection result as glare information; and an image quality correction section that corrects image quality of the display section based on the glare information outputted by the glare detection section.

A display apparatus according to another aspect of the present invention employs a configuration having: a display section that displays at least one image on a screen; a light detection section that detects respective amounts of light reflected toward a plurality of view positions from a representative position on the screen; a storage section that stores set storage information in which one of the plurality of view positions is set per screen of the display section; and a correction section that selects from a plurality of detected values detected by the light detection section a prescribed value based on the set storage information in the storage section and corrects quality of the image displayed on the screen of the display section based on the selected detected value,

### BRIEF DESCRIPTION OF THE DRAWINGS

FIG. 1 is a front view showing the exterior configuration of a display apparatus according to an embodiment of the present invention;

FIG. 2 is a pattern diagram showing as viewed from above the display apparatus of the above embodiment;

FIG. 3 is a diagram showing a specific configuration of a light receiving sensor of the display apparatus of the above embodiment;

FIG. 4 is a diagram showing the corresponding relationship between the glare reflection brightness and the light receiving element voltage of the light receiving sensor of the display apparatus of the above embodiment;

FIG. 5 is a block diagram showing a configuration of the display apparatus of the above embodiment;

FIG. 6 is a diagram showing the set storage information of image displayed on the display of the display apparatus of the above embodiment;

FIG. 7 is a diagram showing the set storage information of the display output setting displayed on the display of the display apparatus of the above embodiment;

FIG. 8 is a diagram showing the set storage information of the screen viewer position setting of the display apparatus of the above embodiment;

FIG. 9 is a diagram showing the set storage information of the image quality adjustment setting of the display apparatus of the above embodiment;

FIG. 10 is a diagram showing an example of a viewer angle table of the display apparatus of the above embodiment;

FIG. 11 is a diagram showing an example of an external light corrected intensity table of the display apparatus of the above embodiment;

FIG. 12 is a diagram explaining the external light correction method corresponding to the view angle the display apparatus of the above embodiment;

FIG. 13 is a pattern diagram showing as viewed from above a display apparatus arranged in the rear of a vehicle when the correction method of FIG. 12 is applied to a plurality of viewers;

FIG. 14 is a flowchart showing a program of the glare image quality correction process of a display location of the display apparatus of the above embodiment;

FIG. 15 is a flowchart showing a program of the glare image quality correction process of a display location of the display apparatus of the above embodiment;

FIG. 16 is a diagram for explaining a display example of a conventional display apparatus capable of displaying a plurality of images in the interior of a vehicle; and

FIG. 17 is a drawing for explaining a display example of a conventional display apparatus that changes luminance by an external light sensor.

### DETAILED DESCRIPTION OF THE PREFERRED EMBODIMENT

Now, embodiments of the present invention will be described in detail with reference to the accompanying drawings.

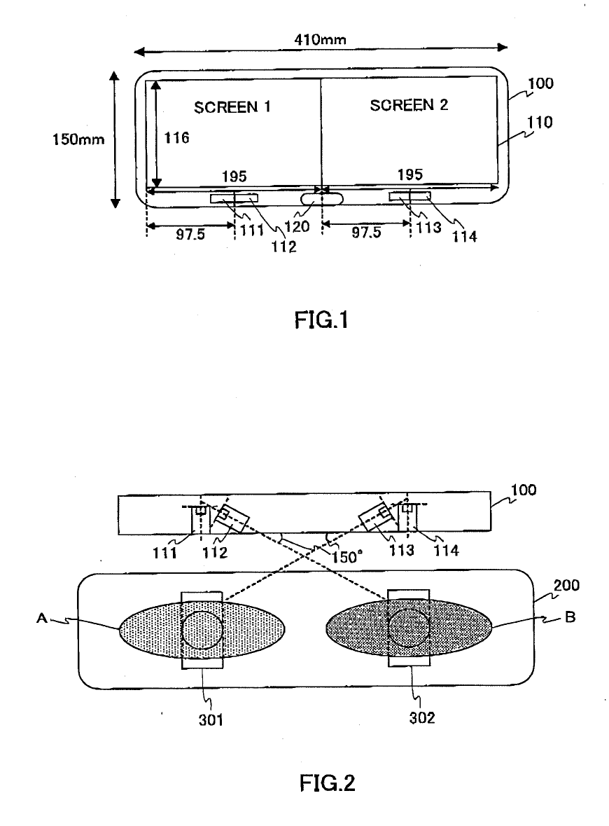

FIG. 1 is a front view showing the exterior configuration of a display apparatus according to an embodiment of the present invention, and FIG. 2 is a pattern diagram showing the display apparatus installed in the rear of the vehicle, seen from above. The present embodiment is an example of applying a display apparatus capable of displaying a plurality of images as a display apparatus for the backseats of a vehicle.

In FIG. 1 and FIG. 2, 100 designates a display apparatus for the backseats, installed in the interior of a vehicle, 200 designates backseats where viewers A and B who view the display screen of the display apparatus 100 are seated, and 301 and 302 designate seat sensors that are installed in the backseats 200 to detect the seated state of viewers A and B.

The display apparatus 100 is comprised of a large-sized, wide LCD panel, for example, and is installed in a location where it is viewable by viewers A and B seated in the rear backseats 200. The display apparatus 100 is fixed near the center of the ceiling inside the vehicle, for example, to allow people seated in the backseats to enjoy images. The display apparatus 100 has an ultra-wide LCD display that is not normally used in typical display apparatus. The numbers in FIG. 1 are examples of actual dimensions in units of mm. With a larger-size LCD panel, naturally, people seated in the backseats are able to view image more comfortably. However, the driver's rear view must not be obstructed, and, as a solution, a new, vehicle-mounted ultra wide LCD display is presently developed and employed. Further, a wide LCD display is particularly suitable in cases where a plurality of screens are displayed side by side in the horizontal direction. An image playback device such as a television tuner, VTR player, digital versatile disc (DVD) player, or vehicle navigation system, etc, is connected to the display apparatus 100, thereby allowing viewers A and B in the backseats to enjoy various images and audio.

The display apparatus 100 has a display panel 110 being a TFT-type landscape LCD panel, four light receiving sensors 111 to 114 that detect the intensity of external light such as sunlight of a specific direction in accordance with dual-screen display and viewer position, and an operation section 120 operated by viewers A and B for various input and setting operations. Further, a backlight (not shown) is arranged on the back of the display panell 110. An image outputted to the display panel 110 is visible by the light from this backlight. The backlight is comprised of a cold cathode fluorescent tube (CCFT), for example, driven by an inverter, but is not limited to this, and a variety of other light sources may be used, including electro luminescence (EL) or a white light emitting diode (LED).

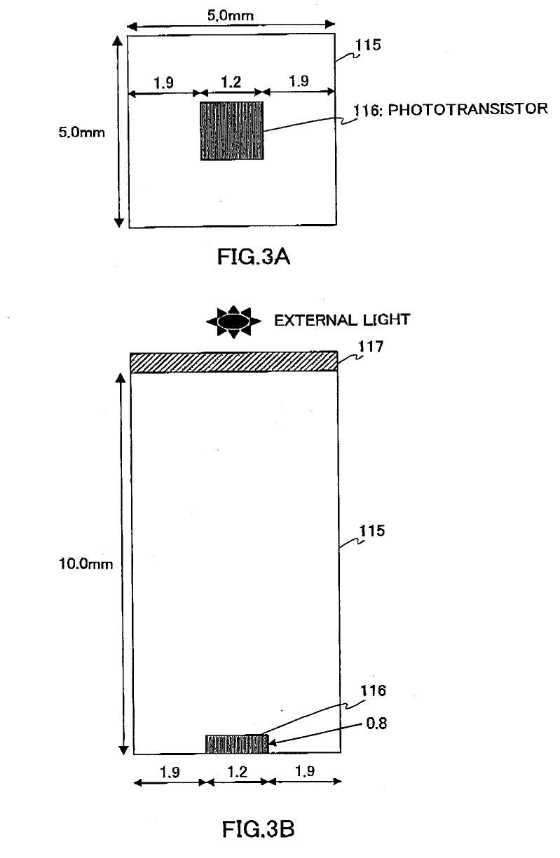

The light receiving sensors 111 to 114 are comprised of, for example, a phototransistor that detects the intensity of external light, the details of which will be described later using FIG. 3. The light receiving sensors 111 to 114 are external light sensors that detect the intensity of external light but differ from conventional external light sensors that detect the surrounding luminance of the display panel as follows; (1) as shown in FIG. 2, the light receiving sensors 111 to 114 selectively detect the light that is reflected from the monitor screen (that is, glare) and that annoys the viewer the most, when the viewer views the monitor, screen from the seated position (hereinafter simply “viewer position”). Further, (2) as shown in FIG. 1, in accordance with the dual-screen (the screen 1 and the screen 2) display on the display panel 110, the light receiving sensors 111 and 112 of the left seat and right seat are installed at the bottom center of the screen 1 on the left side of the display panel 110, and the light receiving sensors 113 and 114 of the left seat and right seat are installed at the bottom center of the screen 2 on the right side of the display panel 110. In the present embodiment, the left seat light receiving sensor 111 that receives the reflected light at the viewer A position and the right seat light receiving sensor 112 that receives the reflected light at the viewer B position are arranged side by side at the bottom center of the screen 1 of the display panel 111, and the left seat light receiving sensor 113 that receives the reflected light at the viewer A position and the right seat light receiving sensor 114 that receives the reflected light at the viewer B position are arranged side by side at the bottom center of the screen 2 of the display panel 111.

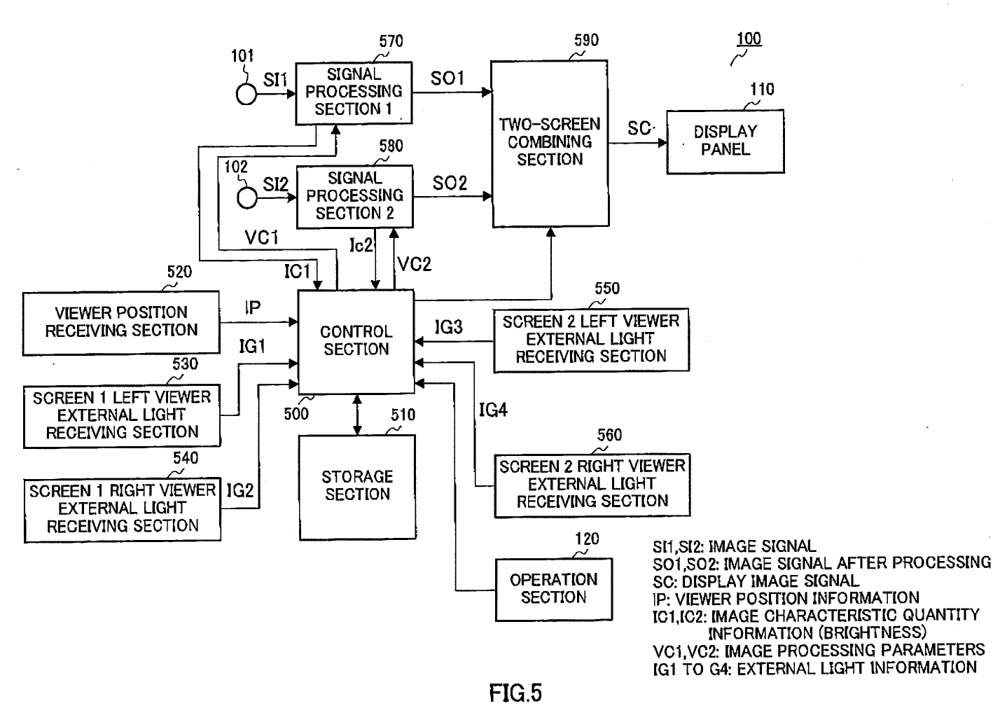

The signals detected by the light receiving sensors 111 to 114 are inputted to the control section 500 shown in FIG. 5 described later. Furthermore, the light receiving sensors 111 to 114 are preferably arranged in locations where they are not influenced by light other than the reflected light seen from the viewer position, particularly the light irradiated from the backlight.

FIG. 3 is a diagram showing a specific configuration of the above-described light sensors 111 to 114, where FIG. 3A is a front view thereof and FIG.3B is a side view thereof. The numbers in FIG. 1 are examples of actual dimensions in units of mm. The light receiving sensors 111 to 114 employ identical configurations and will now be explained using the light receiving sensor 111 as a representative.

In FIG. 3, the light receiving sensor 111 is comprised of a sensor unit 115, a phototransistor 116 which is a light receiving element that is installed on the bottom surface of the sensor unit 115 and detects the intensity of external light irradiated from an external source such as sunlight, and a filter 117 that is installed on the light receiving surface of the sensor unit 115 and attenuates the light so that the intensity of the received light of the light receiving element falls within a measurement range. Furthermore, the light receiving sensors 111 to 114 are not limited to phototransistors and may be photodiodes or solar cells as well.

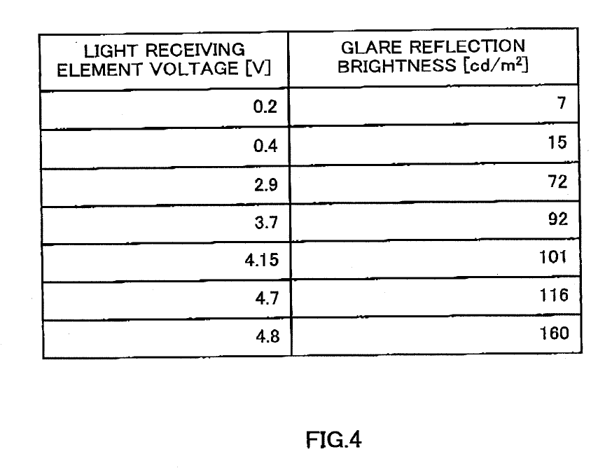

FIG. 4 is a diagram showing the corresponding relationship between the glare reflection brightness and the light receiving element voltage of the light receiving elements of the light receiving sensors 111 to 114. As shown in FIG. 4, the glare reflection brightness [cd/m²] increases in proportion to the increase in the light receiving element voltage (V) of the external light sensors 111 to 114 that detect the intensity of external light. Further, the glare reflection brightness can also be calculated using the straight-line approximation calculation shown in the following equation 1 based on the light receiving element voltage.
Glare reflection brightness=23.753×light receiving element voltage+3.691 (Equation 1)

Using the corresponding relationship chart shown in the above FIG. 4 or the straight-line approximation equation shown in equation 1 above, glare reflection brightness can be estimated from the light receiving element voltage of the external sensors 111 to 114.

The above-described light receiving sensors 111 to 114 have identical configurations, but the installation locations and installation methods vary to accommodate dual-screen display and viewer positions. As shown in FIG. 2, first, the light receiving sensor 111 is installed at the bottom center of the screen 1 of the display panel 111 with the light receiving surface roughly facing the front of viewer A of the left seat, and the neighboring light receiving sensor 112 is installed with the light receiving surface facing the position of viewer B of the right seat. Similarly, the light receiving sensor 113 is installed at the bottom center of the screen 2 of the display panel 110 with the light receiving surface facing the position of viewer A of the left seat, and the neighboring light receiving sensor 114 is installed with the light receiving surface roughly facing the front of viewer B of the right seat. To be more specific, the light receiving sensors 112 and 113 are preferably at 150 degrees with respect to the surface of the display panel 110. Furthermore, as shown in FIG. 1, the light receiving sensors 111 to 114 are coated with clear acrylic resin to maintain an integrated feel with the display surface of the display panel 110.

Returning to FIG. 1, the operation section 120 of the display apparatus 100 has a button for single-screen display of an image source 1 (hereinafter referred to as “image 1”), a button for single-screen display of an image source 2 (hereinafter referred to as “image 2”), a button for dual-screen display, and a button for automatic detection. In addition to the four buttons capable of differentiating “single-screen display of the image 1,” “single-screen display of the image 2,” “dual-screen display,” and “auto detection,” the operation section 120 has various operation buttons and switches. For example, operations such as switching television channels, playing a DVD, and adjusting the volume, are performed using the applicable buttons of the operation section 120. Further, although not shown, the audio accompanying the displayed image on the display apparatus 100 installed for the backseats is outputted to speakers inside the vehicle interior or to headphones or earphones worn by backseat passengers A and B.

The display apparatus 100 may be installed in a variety of ways. For example, it may be hanged from the ceiling inside the vehicle, embedded in the headrest or the back of the frontseat, or installed on the console box or on the floor. In any case, installation is based on the major premise that the rear view of the driver is not obstructed. People seated in the backseats perform operations such as selecting the type of image to be played, switching the channels, and adjusting the screen angles, positions, and audio using the operation buttons of the operation section 120.

The seat sensors 301 and 302 have contact switches, etc., installed in the backseats of the vehicle, and generate a seated detection signal when a passenger sits in a seat, and transmit the signal as seated state information to the display apparatus 100. A plurality of seat sensors 301 and 302 (two in the present embodiment) are arranged in the length direction of the backseats 200, so that the seated location of each passenger can be detected. Needless to say, three or more seat sensors 301 and 302 may be installed. Further, devices such as piezoelectric element based pressure sensors, weight sensors, body detection sensors based on radiant temperature detection inside the vehicle interior, or monitoring cameras that monitor the state inside the vehicle interior by video may be used in place of the seat sensors having contact switches, etc. Furthermore, the seat sensor 301 may be a switch (such as a contact switch) that is installed in a seatbelt part to detect whether or not passenger (viewer) A is seated in the left seat by detecting whether or not the seatbelt is worn. Similarly, the seat sensor 302 may be a switch (such as a contact switch) that is installed in a seatbelt part to detect whether or not passenger (viewer) B is seated in the right seat by detecting whether or not the seatbelt is worn.

FIG. 5 is a block diagram showing the configuration of the above-described display apparatus 100.

In FIG. 5, the display apparatus 100 has: a control section 500 having a microprocessor, controls display of the overall apparatus and, based on the read information from the receiving sections 520, 530, 540, 550 and 560 and image characteristic quantity information (brightness) Ic1 and Ic2 from the signal processing sections 570 and 580, refers to information of the storage section 510, performs the processing of correcting image quality in accordance with the glare caused by the display location, outputs image processing parameters Vc1 and Vc2, and controls image synthesis in the two-screen combining section 590; a storage section 510 that has a semiconductor memory and stores various setting information for the control program and display control executed by the microprocessor; an operation section 120 that outputs operation information such as the pressing of a button switch; a viewer position receiving section 520 that is connected to the seat sensors 301 and 302 and receives the viewer position information Ip detected by these sensors 301 and 302; a screen 1 left viewer external light receiving section 530 that is connected to a light receiving sensor 111 and receives the external light information Ig1 detected by the sensor 111; a screen 1 right viewer external light receiving section 540 that is connected to a light receiving sensor 112 and receives the external light information Ig2 detected by the sensor 112; a screen 2 left viewer external light receiving section 550 that is connected to a light receiving sensor 113 and receives external light information Ig3 detected by the sensor 113; a screen 2 right viewer external light receiving section 560 that is connected to light receiving sensor 114 and receives external light information Ig4 detected by the sensor 114; a signal processing section 570 (signal processing section <1>) that processes image signal Si1 inputted to image input terminal 101 in accordance with image processing parameter Vc1; a signal processing section 580 (signal processing section <2>) that processes image signal Si2 inputted to image input terminal 102 in accordance with image processing parameter Vc2; a two-screen combining section 590 that combines the screens of image signals So1 and So2 after signal processing based on the control signal of the control section 500 and outputs the combined screen display image signal Sc; and a display panel 110 that displays display image signal Sc outputted from the two-screen combining section 590. The display apparatus 100 further has a loudspeaker (notshown). Furthermore, the display apparatus 100 may further have a microphone for speech input and a speech signal processing section and a speech recognition section for digital signal processing of received signals and speech signals inputted from the microphone, thereby enabling operation by speech input.

The display panel 110 is comprised of a wide LCD display of a dot-matrix structure. An organic electro luminescence (EL) display apparatus, a plasma display panel (PDP) apparatus, a CRT display apparatus, or a projector-type display apparatus may be used in place of the LCD display. The display panel 110 displays various screens for viewers in the backseats, such as icons that indicate the operation states of the display functions. Further, in remote control function mode or video output function mode, various operation information and volume adjustment graphical user interface (GUI) are displayed.

The operation section 120 inputs viewer position settings and ON/OFF settings for glare image quality correction processing by a remote controller, escutcheon buttons or a vehicle-mounted local area network (LAN)

The viewer position receiving section 520 receives the voltage values detected by the seat sensors 301 and 302 as viewer position information Ip. In place of or in combination with the seat sensors 301 and 302, the viewer position receiving section 520 may receive the voltage value of the detected signal of the seatbelt or digital information of a charge coupled device (CCD) camera that takes an image of seated viewers and image recognition information from an image recognition engine. Further, the viewer position receiving section 520 may receive viewer position information manually inputted by remote controller or escutcheon buttons, for example, or viewer position information inputted to the navigation system around the frontseat (the navigation system around the driver's seat) via a vehicle-mounted LAN.

The signal processing sections 570 and 580 have a digital signal processor (DSP) for example, obtain image processing parameters Vc1 and Vc2 from the control section 500, incorporate image signals Si1 and Si2 inputted to the image input terminals 101 and 102, and performs signal processing on a per pixel basis in accordance with image processing parameters Vc1 and Vc2.

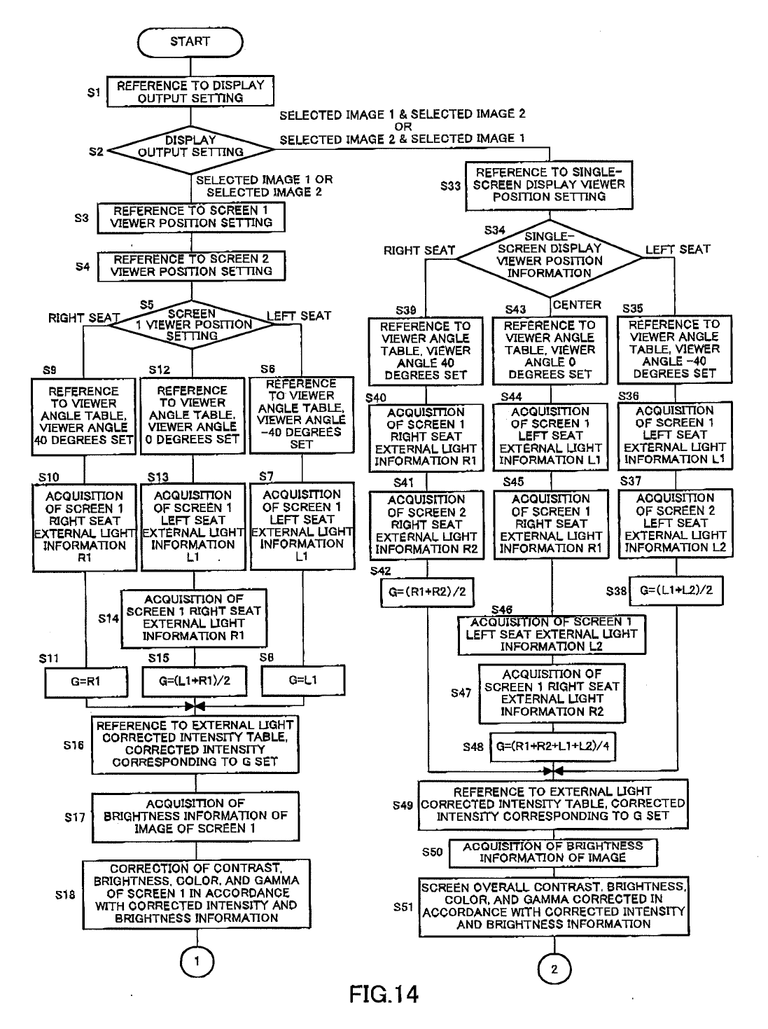

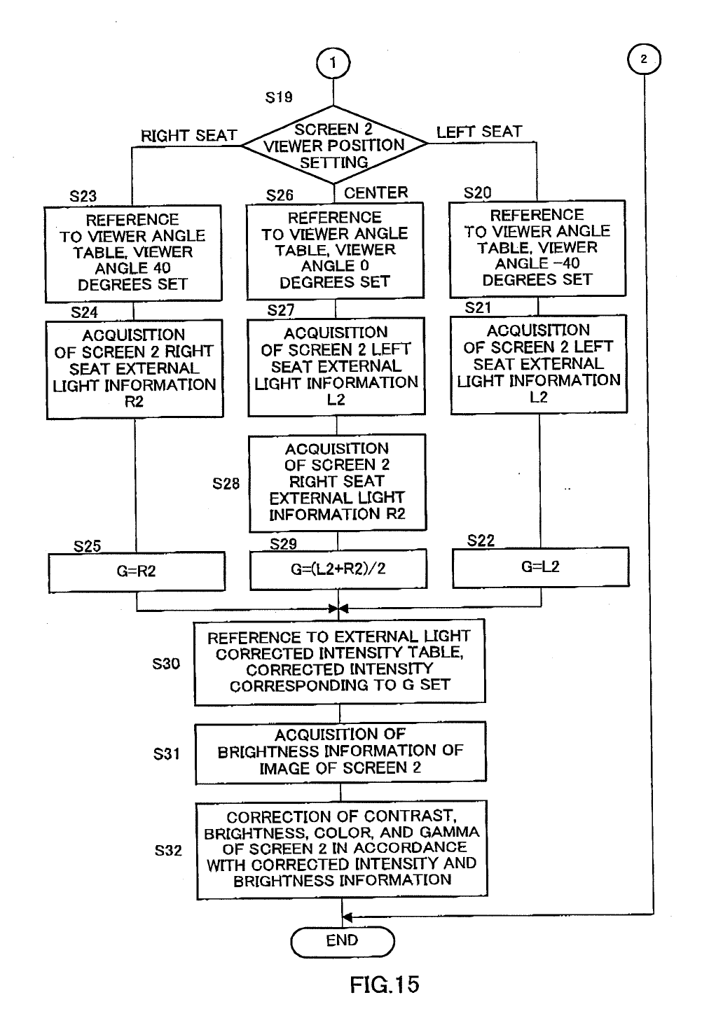

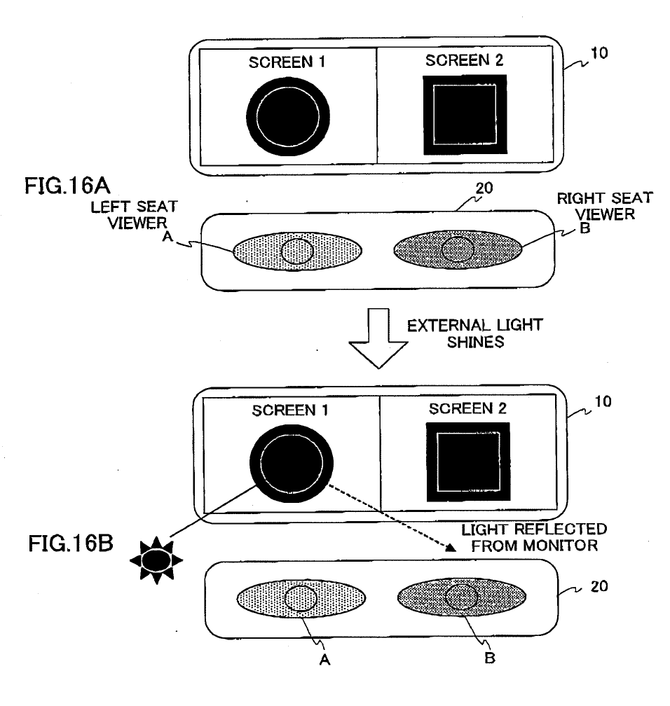

The control section 500 has a microprocessor and performs control by executing glare image quality correction processing of the display location (described later) using FIG. 14 and FIG. 15, obtaining read information from the receiving sections 520, 530, 540, 550 and 560 and image characteristic quantity information (brightness) Ic1 and Ic2 from the signal processing sections 570 and 580, and referring to the table of light receiving sensor values, pixel positions, and gain correction coefficients from the storage section 510 and the setting in the signal processing sections 570 and 580 the image processing parameters Vc1 and Vc2.

Further, the control section 500 outputs the control signal to the two-screen combining section 590 and controls image synthesis in the two-screen combining section 590.

The two-screen combining section 590 combines the screens for processed image signals So1 and So2 outputted from the signal processing sections 570 and 580, based on the control signal from the control section 500.

The storage section 510 is typified by a semiconductor memory such as ROM that stores the control program and fixed data and RAM that is a work storage area for the microprocessor, etc. Further, the storage section 510 may have a storage medium such as an SD card or HDD as external memory. ROM is read-only semiconductor memory that stores programs and fixed data such as display control data that are required when the control section 500 operates. RAM is used as so-called working memory that temporarily stores data such as data related to glare image quality correction processing and operation results. The program processed in the display apparatus 100 is invoked and executed on this RAM. Further, part of RAM is formed with an electrically erasable programmable ROM (EEPROM), which is an electrically rewritable nonvolatile memory, thereby enabling changes in various specifications of the display apparatus 100 in particular, by changing the programs written in EEPROM.

The storage section 510 stores the light receiving sensor values, pixel positions, arid gain correction coefficient table as data related to glare image quality correction processing.

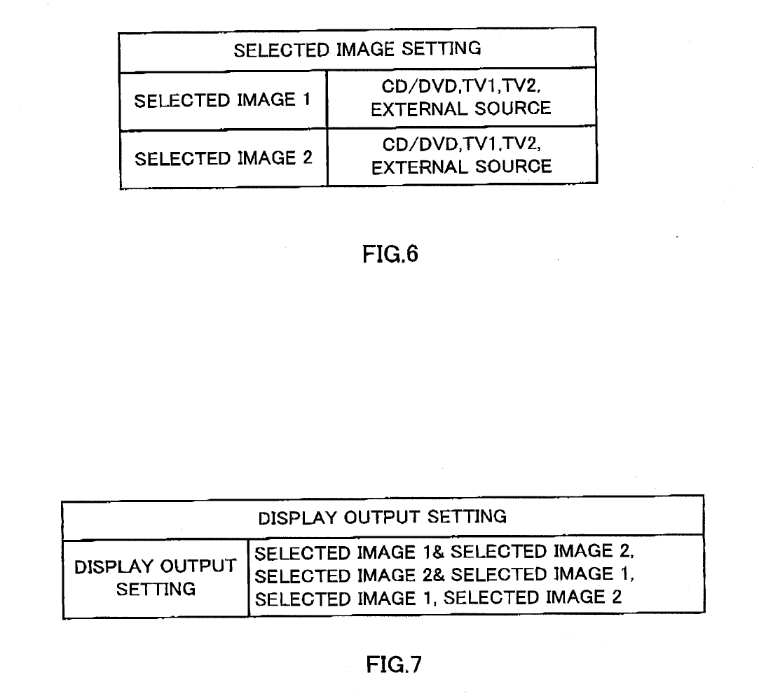

FIG. 6 to FIG. 11 show an example of set storage information stored in the storage section 510. Part of the set storage information is stored as a look-up table.

FIG. 6 is a diagram showing the set storage information of an image displayed on the display. The selected images include a selected image 1 and a selected image 2, and the image sources for dual-screen display on the display panel 110 include CD/DVD playback, TV1, TV2, and external signal input.

FIG. 7 is a diagram showing the set storage information for the display output setting displayed on the display. One of the selected image 1, selected image 2, selected image 1 and selected image 2, and selected image 2 and selected image 1, is selected for the display output setting. With this display output setting, the selected image 1 and selected image 2 are set individually or in combination.

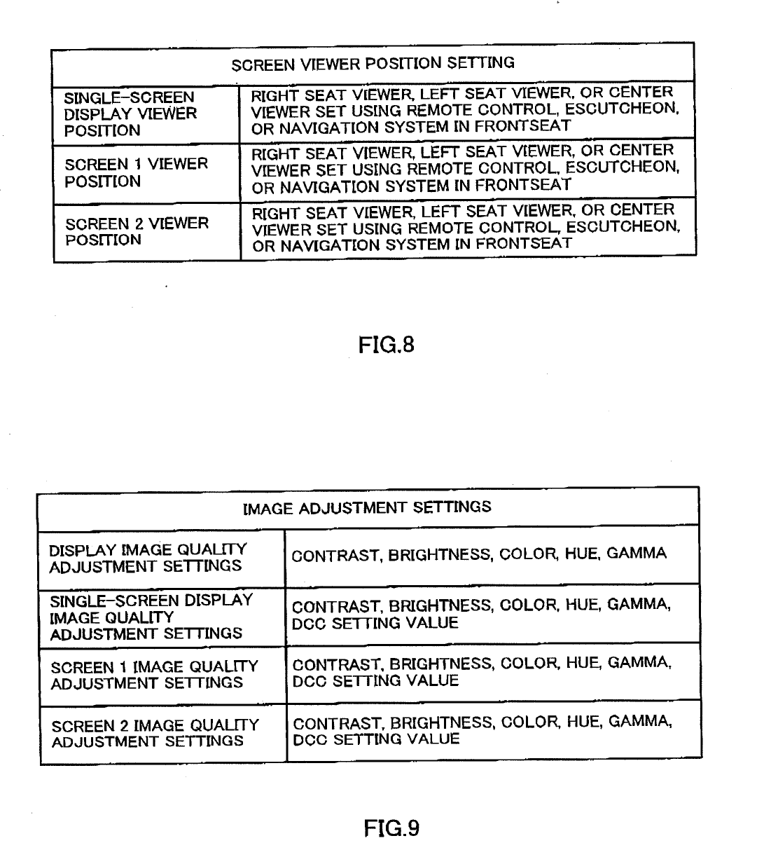

FIG. 8 is a diagram showing the set storage information for the screen viewer position setting. The screen viewer position setting sets one of a plurality of viewer positions for each display screen, such as a single-screen display viewer position, a screen 1 viewer position, or a screen 2 viewer position. Single-screen display viewer position setting is the setting of the target viewer position during single-screen display. Screen 1 viewer position setting is the setting of the target viewer position for the screen 1 during dual-screen display, and screen 2 viewer position setting is the setting of the target viewer position for the screen 2 during dual-screen display. For each screen viewer position setting, the right seat viewer, left seat viewer, or center viewer is set using a remote controller, escutcheon buttons, or the navigation system in the frontseat.

FIG. 9 is a diagram showing set storage information for image quality adjustment settings. The image quality adjustment settings are divided into display image quality adjustment settings for adjusting image quality in accordance with display characteristics, and single-screen display image quality adjustment settings, screen 1 image quality adjustment settings, and screen 2 image quality adjustment settings for adjusting image quality in accordance with the glare caused by the display location. The above-described display image quality adjustment settings adjust image quality characteristics of the display itself and are not often reset. On the other hand, the single-screen display image quality adjustment settings that set the image quality adjustment values during single-screen display, the screen 1 image quality adjustment settings that set the image quality adjustment values of the screen 1 during dual-screen display, and the screen 2 image quality adjustment settings that set the image quality adjustment values of the screen 2 during dual-screen display are appropriately set according to viewer position, external light information, etc. The above-described display image quality adjustment settings set the various correction information including contrast, brightness, color, hue, and gamma, and the above-described single-screen display image quality adjustment settings, screen 1 image quality adjustment settings, and screen 2 image quality adjustment settings further set the DCC setting value.

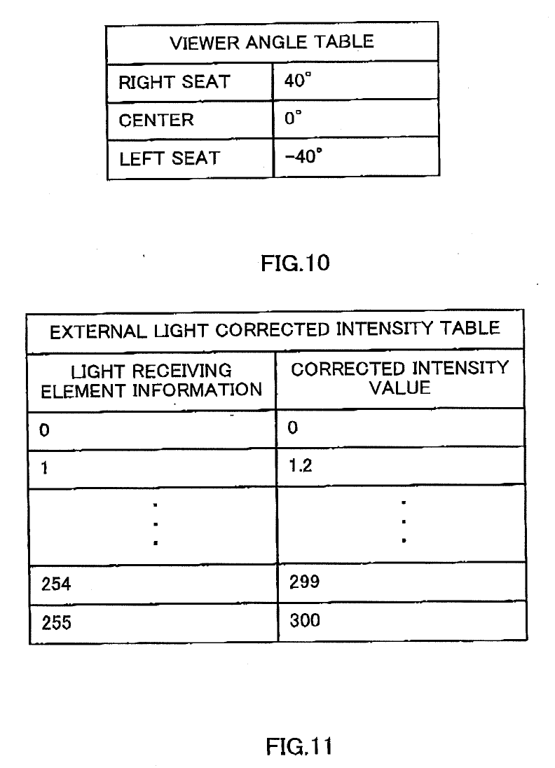

FIG. 10 is a diagram showing an example of a viewer angle table. As shown in FIG. 10, as viewed from the front of the display panel 110, the right seat position is set to a viewer angle of 40 degrees, the center to a viewer angle of 0 degree, and the left seat position to a viewer angle of −40 degrees. For example, a viewer angle of −40 degrees is set when a viewer sits in the left seat of the backseats 200, and a viewer angle of −40 degrees is set when a viewer sits in the right seat of the backseats 200. Further, a viewer angle of 0 degree is set when one viewer sits in the center seat, when two or more viewers sit in the left and right seats of the backseats 200.

FIG. 11 is a diagram showing an example of an external light corrected intensity table. As shown in FIG. 11, the corrected intensity values 0, 1, 2, . . . , 299, 300 that correspond respectively to the bits of light receiving element information 0 to 255 are set.

Now, the operation of the display apparatus configured as above will be described.

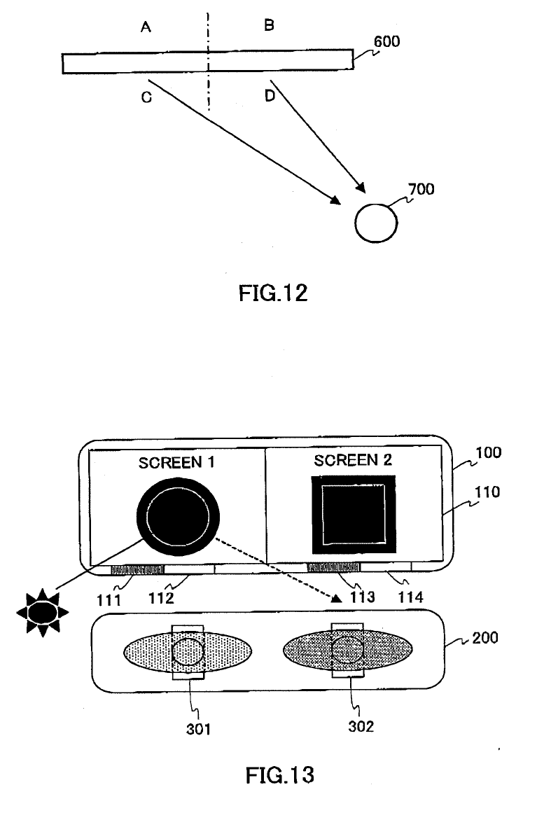

FIG. 12 is a diagram for explaining an external light correction method according to view angle.

In FIG. 12, the area of the display 600 is separated into two areas A and B, and the external light intensity of the representative points C and D are measured 700 designates the viewer position. The above the representative points C and D are, for example, the center points of the display areas A and B.

The intensity in the display area A is corrected using the corrected intensity value obtained from the representative point C, and the intensity in the display area B is corrected using the corrected intensity value obtained from the representative point D, based on the external light corrected intensity table shown in the above-described FIG. 11 and the measured external light intensity. In the present embodiment, as shown in FIG. 1 and FIG. 2, the light receiving sensors 111 and 112 and the light receiving sensors 113 and 114, which exemplify external light intensity detection means, are provided in two lower locations of the display panel 110. Further, the seat sensors 301 and 302, which exemplify viewer position detection means, detect viewer positions.

The number of divisions of the area of the above-described display 600 is not limited to 2 and may be 3 or more. Further, the representative points C and D where the external light intensity detection means are provided are not limited to the center points in display areas. Further, even in the case of single-screen display, the screen area may be divided into A and B (or more areas) and the external light corrected intensity may be given for each area.

Here, when there are a plurality of viewers, one of the following processes is selected:
(1) The display process in accordance with the view angle is set to OFF.
(2) When there are two viewers and the viewers are seated in symmetrical positions with respect to the center of the display, the average of the external light sensors is found and that average value is used.
(3) The viewer position of the main or representative party is inputted or preset and coordination with this viewer position is made.
(4) When a plurality of screens are displayed and a viewer is set for each screen, optimal correction is performed for the plurality of viewers on a per screen basis.

FIG. 13 is a pattern diagram showing from above a display apparatus installed in the rear of a vehicle when the correction method of FIG. 12 is applied to a plurality of viewers. Components that are identical to those of FIG. 2 are assigned the same reference numerals.

As shown in FIG. 13, a plurality of light receiving sensors 111 and 112 and light receiving sensors 113 and 114 that detect light reflected toward the viewer are installed in association with viewer positions and dual-screen display, and, based on the information detected by light receiving sensors 111 to 114, corrections are made on a per screen basis.

More specifically, the light receiving sensor 111, the light receiving sensor 112, the light receiving sensor 113, and the light receiving sensor 114 are external light sensors that estimate the light reflected from the screen 1 toward the left seat, the light reflected from the screen 1 toward the right seat, the light reflected from the screen 2 toward the left seat, and the light reflected from the screen 2 toward the right seat, respectively.

Further, the seat sensors 301 and 302 detect viewer positions.

FIG. 14 and FIG. 15 are flowcharts showing the program for the glare image quality correction process of the display location, and the program is executed by the microprocessor constituting the control section 500. In the figure, “S” stands for a step in the flow.

First, in step S1, the control section 500 refers to the display output settings (FIG. 7) stored in the storage section 510, and, in step S2, identifies the display output setting that was referred to. The display output settings include the selected image 1, selected image 2, selected image 1 and selected image 2, and selected image 2 and selected image 1, and the control section 500 identifies which of these settings is set. The selected images 1 and 2 are, for example, CD/DVD playback, TV1, TV2, or an external signal input.

The subsequent processing performed differs greatly between the case where one image source (the selected image 1 or selected image 2) is set and the case where a combination of two image sources (the selected image 1 and selected image 2, etc.) is set in the above-mentioned step S2.

When the selected image 1 or selected image 2 is set by the display output setting, the control section 500, in step S3, refers to the screen 1 viewer position setting of the screen viewer position settings (FIG. 8) stored in the storage section 510, and, in step S4, refers to the screen 2 viewer position setting of the above-mentioned screen viewer position settings. The screen 1 viewer position setting is the setting of the target viewer position for the screen 1 during dual-screen display, and the screen 2 viewer position setting is the setting of the target viewer position for the screen 2 during dual-screen display. For the screen land screen 2 viewer position settings, the control section 500 sets the target viewer as the right seat viewer, left seat viewer or center viewer. This screen viewer position setting is set by operation of the remote control or escutcheon buttons using the operation section 120, or driver operation using the navigation system in the frontseat.

In step S5, the control section 500 identifies whether the target viewer according to the screen 1 viewer position setting is the right seat viewer, left seat viewer or center viewer. When the target viewer according to the screen 1 viewer position setting is the left seat viewer, the control section 500, in step S6, refers to the viewer angle table (FIG. 10) and sets the viewer angle to −40 degrees, and, in step S7, obtains the screen 1 left seat external light information L1. To be more specific, the control section 500 obtains external light information Ig1 from the screen 1 left viewer external light receiving section 530. Next, control section 500, in step S8, sets the obtained screen 1 left seat external light information L1 to corrected intensity (control target value) G (G=L1), and proceeds to step 516.

When the target viewer according to the screen 1 viewer position setting is the right seat viewer in the above step SS, the control section 500, in step S9, refers to the viewer angle table (FIG. 10) and sets the viewer angle to −40 degrees, and, in step S10, obtains the screen 1 right seat external light information R1. To be more specific, the control section 500 obtains external light information Ig2 from the screen 1 right viewer external light receiving section 540. Next, the control section 500, in step S11, sets the obtained screen 1 right seat external light information R1 to corrected intensity (control target value) G (G=R1) and proceeds to step S16.

When the target viewer according to the screen 1 viewer position setting is the center viewer in the above step S5, the control section 500, in step S12, refers to the viewer angle table (FIG. 10) and sets the viewer angle to 0 degree. Next, the control section 500, in step S13, obtains screen 1 left seat external light information L1, and, in step S14, obtains screen 1 right seat external light information R1. Next, the control section 500, in step S15, sets the corrected intensity (control target value) G in accordance with the following equation 2 based on the obtained screen 1 left seat external light information L1 and screen 1 right seat external light information R1, and proceeds to step S16.
G=(L1+R1)/2 (Equation 2)

In step S16, control section 500 refers to the external light corrected intensity table (FIG. 11) and sets the corrected intensity corresponding to G, and, in step S17, obtains brightness information of the image of the screen 1.

Next, the control section 500, in step S18, corrects the contrast, brightness, color, hue, sharpness, and/or gamma of the screen 1 based on the set corrected intensity G and obtained brightness information, and proceeds to step 19 (FIG. 15). Here, for glare image quality correction, the contrast, brightness, color, hue, sharpness, and gamma parameter combinations that are most effective with respect to glare and result in minimum image quality loss, and their corrected amounts are calculated in advance by experiment.

In step S19 , the control section 500 identifies whether the target viewer according to the screen 2 viewer position setting is the right seat viewer, left seat viewer, or center viewer. When the target viewer according to the screen 2 viewer position setting is the left seat viewer, the control section 500, in step S20, refers to the viewer angle table (FIG. 10) and sets the viewer angle to −40 degrees, and, in step S21, obtains the screen 2 left seat external light information L2. To be more specific, the control section 500 obtains external light information Ig3 from the screen 2 left viewer external light receiving section 550. Next, the control section 500, in step S22, sets the obtained screen 2 left seat external light information L2 to corrected intensity (control target value) G (G=L2) and proceeds to step S30.

When the target viewer according to the screen 2 viewer position setting is the right seat viewer in the above step S19, the control section 500, in step S23, refers to the viewer angle table (FIG. 10) and sets the viewer angle to −40 degrees and, in step S24, obtains the screen 2 right seat external light information R2. To be more specific, the control section 500 obtains external light information Ig4 from the screen 2 right viewer external light receiving section 560. Next, control section 500, in step S25, sets the obtained screen 2 right seat external light information R2 to corrected intensity (control target value) G (G=R2) and proceeds to step S30.

When the target viewer according to the screen 2 viewer position setting is the center viewer in the above step S19, the control section 500, in step S26, refers to the viewer angle table (FIG. 10) and sets the viewer angle to 0 degree. Next, the control section 500, in step S27, obtains screen 2 left seat external light information L2, and, in step S28, obtains screen 2 right seat external light information R2. Next, the control section 500, in step S29, sets the corrected intensity (control target value) G in accordance with the following equation 3 according to the obtained screen 2 left seat external light information L2 and screen 2 right seat external light information R2, and proceeds to step S30.
G=(L2+R2)/2 (Equation 3)

In step S30, the control section 500 refers to the external light corrected intensitytable (FIG. 11) and sets the corrected intensity corresponding to G, and, in step S31, obtains brightness information of the image of the screen 2.

Next, the control section 500, in step S32, corrects the contrast, brightness, color, hue, sharpness, and/or gamma of the screen 2 based on the set corrected intensity G and obtained brightness information, and ends the process flow.

The above process is the process for the case where the selected image 1 or selected image 2 is set by the display output setting.

On the other hand, when a combination of two image sources (selected image 1 and selected image 2, or selected image 2 and selected image 1) is set in the above step S2, control section 500, in step S33, refers to the single-screen display viewer position setting of the screen viewer position settings (FIG. 8) stored in the storage section 510 and, in step S34, identifies whether the target viewer according to the single-screen display viewer position setting is the right seat viewer, left seat viewer, or center viewer. When the target viewer according to the single-screen display viewer position setting is the left seat viewer, the control section 500, in step S35, refers to the viewer angle table (FIG. 10) and sets the viewer angle to −40 degrees, obtains, in step S36, the screen 1 left seat external light information L1, obtains in step S37 the screen 2 left seat external light information L2, sets in step S38 the corrected intensity (control value target) G in accordance with the following equation 4 based on the obtained screen 1 left seat external light information L1 and screen 2 left seat external light information L2, and proceeds to step S49.
G=(L1+L2)/2 (Equation 4)

When the target viewer according to the single-screen display viewer position setting is the right seat viewer in the above step 334, the control section 500, in step S39, refers to the viewer angle table (FIG. 10) and sets the viewer angle to −40 degrees, obtains in step S40 the screen 1 right seat external light information R1, obtains in step S41 the screen 2 right seat external light information R2, sets in step S42 the corrected intensity (control value target) G in accordance with the following equation S based on the obtained screen 1 right seat external light information R1 and screen 2 right seat external light information R2, and proceeds to step S49.
G=(R1+R2)/2 (Equation 5)

When the target viewer according to the single-screen display viewer position setting is the center viewer in the above step S34, the control section 500, in step S43, refers to the viewer angle table (FIG. 10) and sets the viewer angle to 0 degree and, in step S44, obtains the screen 1 left seat external light information L1 and, in step S45, obtains the screen 1 right seat external light information R1. Next, the control section 500, in step S46, obtains screen 2 left seat external light information L2, and, in step S47, obtains screen 2 right seat external light information R2. Next, the control section 500, in step S48, sets the corrected intensity (control target value) G in accordance with the following equation 6 based on the obtained screen 1 left seat external light information L1, screen 1 right seat external light information R1, screen 2 left seat external light information L2, and screen 2 right seat external light information R2, and proceeds to step S49.
G=(R1+R2+L1+L2)/4 (Equation 6)

In step S49, the control section 500 refers to the external light corrected intensity table (FIG. 11) and sets the corrected intensity corresponding to G, and, in step S50, obtains brightness information of the image.

Next, the control section 500, in step S51, corrects the contrast, brightness, color, hue, sharpness, and/or gamma of the overall screen based on the set corrected intensity G and obtained brightness information, and ends the process flow.

As described above, according to the present embodiment, the display apparatus 100 has: a display panel 110 that is installed in the interior of a vehicle and displays image on a display screen; a viewer position receiving section 520 that include the seat sensors 301 and 302 and outputs detected viewer position information; viewer external light receiving sections 540 to 560 that output sensor values indicating the amount of light reflected from the screen with respect to each viewer; and a storage section 510 that stores table of sensor values, pixel positions and gain correction coefficients related to glare image quality correction processing, and various other information, and, in this apparatus, the control section 500, based on the read information from each receiving section 520 to 560 and the image characteristic quantity information (brightness) Ic1 and Ic2 from the signal processing sections 570 and 580, refers to the information (particularly the set storage information for the screen viewer position settings shown in FIG. 8) of the storage section 510, performs processing of correcting the image quality in accordance with the glare caused by the display location, and outputs image processing parameters Vc1 and Vc2; and signal processing sections 570 and 580 adjust the image quality of image signals Si1 and Si2 based on the image processing parameters Vc1 and Vc2 that reflect glare image quality correction, thereby improving the visibility for each viewer with respect to the glare caused by external light particularly on the vehicle-mounted display apparatus 100 having a landscape display and located in close proximity to each viewer seated in the backseats of the vehicle.

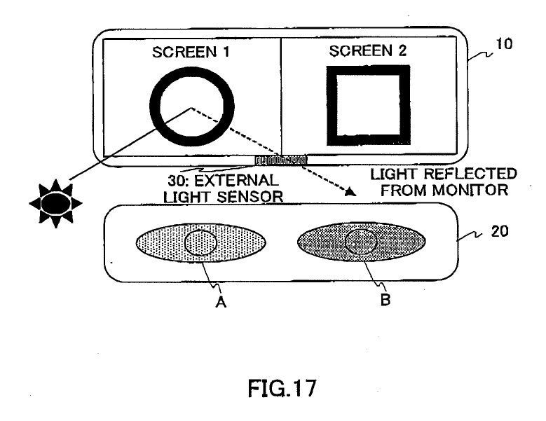

For example, a case will be described here where, as shown in FIG. 13, when viewers A and B are seated in the backseats 200 of a vehicle and viewer A views TV on the screen 1 and viewer B views a DVD on screen 2, sunlight enters from the left side of the vehicle and reflects on the display panel 110. In this case, viewer B is severely influenced by reflected light while viewer A is not influenced to the extent of viewer B. In the display panel 110, the left seat and right seat light receiving sensors 111 and 112 and the light receiving sensors 113 and 114 are installed for the screen 1 and screen 2, the values that indicate the amount of light reflected from the screen 1 and the screen 2 toward viewers A and B, respectively, are detected, and the control section 500 corrects image quality (such as the contrast, brightness, and color) of each of the images 1 and 2 of the display panel 110 based on the sensor values of the screen 1 and the screen 2. Now, if the viewed screens of the viewers are set by the selected image settings and glare image quality correction for the screens 1 and 2 is set by the dual-screen display setting, viewer A viewing the screen 1 is not influenced by the reflected light while viewer B viewing the screen 2 is subjected to reflected light from the screen 1 but only minimal reflected light from the viewed screen 2. In consequence, glare image quality correction of the screen 1 viewed by viewer A is not performed and glare image quality correction of the screen 2 viewed by viewer B is not performed either. The absence of image quality correction means that the image quality adjustment setting values (including default values) preset by the viewer are applied as is, and so good image quality is maintained. The above is merely one example, and, in other cases, the image quality of the screens 1 and 2 maybe corrected depending on the display output setting. For example, to view the screen 2 and screen 1 according to the display output setting, glare image quality correction is performed for the screen 1, thus enabling viewer B to view the screen 1 where the influence of glare is alleviated. The influence of the above, in comparison to the conventional example shown in FIG. 17, is clear.

In this manner, according to the present embodiment, the glare of external light with respect to the viewer is detected and image quality is corrected based on this glare information, thereby enabling, on the landscape panel 111 that is partially susceptible to glare from external light, the alleviation of the influence of the glare of external light in accordance with the view of the viewer and the maintenance of good image quality on the overall screen.

Further, according to the present invention, the viewer can set settings such as image quality adjustment settings and screen viewer position settings using the operation section 120, so that the optimum image is displayed in accordance with viewer's needs. Further, the position of a viewer seated in the backseats is detected by the seat sensors 301 and 302, making possible optimal glare image quality correction in accordance with the position of the viewer and making it possible to appropriately adjust glare in the left and right part of the display of the display panel 110 having a landscape display viewed in close proximity. Further, the present embodiment is particularly effective during dual-screen display. Thus, the influence of glare is alleviated to a maximum possible extent for a plurality of viewers, thereby achieving a display apparatus that provides comfortable viewing.

Furthermore, while the present embodiment performs image quality correction in accordance with glare, the brightness of the backlight of the display panel 110 may also be adjusted using the control amount obtained by this same method. If the display apparatus uses a white LED backlight pack as the backlight source, the brightness can be adjusted on the left and right part of the landscape display.

The above descriptions provide illustrations of preferred embodiments of the present invention, but the scope of the invention is not limited thereto. For example, the following additional configurations may be employed: (1) a means that sets in advance a specific display mode when image quality is to be corrected in accordance with glare and reads and reflects this display mode in image quality correction processing, (2) a means that performs image quality correction for a predetermined representative party only; (3) a means that performs image correction on a per screen basis; and (4) a means that sets the image quality correction processing to OFF.

While an example has been described with this embodiment where a display apparatus viewed from the backseats of a vehicle is applied as the display apparatus, the display apparatus applied may be similar display apparatus mounted in another vehicle. Further, the display apparatus applied may be any type of display apparatus outside a vehicle that is installed in a space where external light is bothersome.

Further, the configuration examples of FIG. 1 and FIG. 2 are merely examples, and any type of configuration, such as a configuration where the number of seats and image inputs is 3 or more may be applied.

Although the above-described embodiment uses the term “display apparatus,” this term is used for the sake of convenience and may be, for example, “vehicle-mounted display apparatus” or “vehicle-mounted electronic device,” etc.

Furthermore, the types, quantities, and connection method of each circuit section, such as the signal processing section, constituting the above-described display apparatus are not limited to those of the above-described embodiment.

Further, with the above display apparatus, a program for operating the display apparatus is also realized. This program is stored in a computer-readable recording medium.

As described above, according to the present invention, with unique vehicle-mounted display apparatus, capable of dual-screen display, used where a plurality of viewers are seated side by side and where the viewers view the screen from extremely close positions, it is possible to reduce the influence of light reflected from the screen toward each viewer and improve visibility.

Consequently, the display apparatus according to the present invention is effective as a vehicle-mounted display apparatus installed in the interior of a vehicle. Further, the display apparatus according to the present invention sets settings and performs image quality adjustment according to single-screen or dual-screen display viewer position information, thereby improving the ease of use of the display apparatus according to the present invention. Further, the present invention maybe applied to the applications of products that have a plurality of display apparatuses that include a display section and operation section. The present invention is also suitable for use as a display apparatus that is installed in a space where visibility deteriorates due to external liqht, even in locations outside a vehicle.

What is claimed is:

1. A display apparatus comprising:
a display section that displays image on a display screen;
a viewer position reading section that reads a relative position of at least one viewer with respect to the display screen;
a glare detection section that detects light reflected from external light toward the viewer to output the detection result as glare information; and
an image quality correction section that corrects image quality of the display section based on the glare information outputted by the glare detection section.

2. The display apparatus according to claim 1, wherein:
the display screen is divided into a plurality of partial screens; and
the viewer position reading section reads the relative position of the viewer with respect to at least one of the plurality of partial screens.

3. The display apparatus according to claim 1, wherein:
the viewer position reading section reads positions of a plurality of viewers viewing the image on the display screen; and
the glare detection section detects the glare of external light with respect to the plurality of viewers.

4. The display apparatus according to claim 1, wherein the image correction section corrects at least one of image quality adjustment parameters including contrast, brightness, color, hue, color gain, sharpness and gamma.

5. A display apparatus comprising:
a display section that displays at least one image on a screen;
a light detection section that detects respective amounts of light reflected toward a plurality of view positions from a representative position on the screen;
a storage section that stores set storage information in which one of the plurality of view positions is set per screen of the display section; and
a correction section that selects from a plurality of detected values detected by the light detection section a prescribed value based on the set storage information in the storage section and corrects quality of the image displayed on the screen of the display section based on the selected detected value.
